(19) United States
(12) Patent Application Publication
(10) Pub. No.: US 2007/0156854 A1
(43) Pub. Date: Jul. 5, 2007

(54) A SYSTEM FOR GRABBING IMAGES FROM AN IP CAMERA

(75) Inventors: SHOU-KANG WEI, CHUNG HO CITY (CN); CHI-HSIEN SHIH, CHUNG HO CITY (CN); CHIN-CHIH LIANG, CHUNG HO CITY (TW); HSI-TSUNG CHENG, CHUNG HO CITY (CN); MAO-CHENG WU, CHUNG HO CITY (CN)

Correspondence Address: LOWE HAUPTMAN BERNER, LLP, 1700 DIAGONAL ROAD, SUITE 300, ALEXANDRIA, VA, 22314, US

(73) Assignee: AverMedia TECHNOLOGIES, INC., CHUNG HO CITY (CN)

(21) Appl. No.: 11/380,906

(22) Filed: Apr. 28, 2006

(30) Foreign Application Priority Data
Jan. 3, 2006 (TW) 95100224

(51) Int. Cl. G06F 15/16

(52) U.S. Cl. 709/219

(57) ABSTRACT

A system for grabbing images from an IP Camera, the system has a mounted Digital Video Recorder (DVR) and an installed IP Camera Module, the IP Camera Module simulates the behavior of a web page navigator retrieving data from a website when data is requested from an embedded website on the IP Camera to grab instant image data in JPEG image file format from the IP Camera, and then send the image data to the Digital Video Recorder for processing.

### RELATED APPLICATIONS

The present application is based on, and claims priority from, Taiwan Application Ser. No. 95100224, filed Jan. 03, 2006, the disclosure of which is hereby incorporated by reference herein in its entirety.

### BACKGROUND

1. Field of Invention

The present invention relates to an image grabbing system. More particularly, the present invention relates to a system for grabbing images from an IP Camera.

2. Description of Related Art

Progress in network technology, for the purposes of controlling or communication, had led to IP Cameras being combined with networks. The IP Camera usually has an embedded website, therefore it does not require a dedicated connection to the computer hardware, and only needs to use a network (cable) and a power supply to operate. A user can use a computer which connects to the network to login into the IP Camera by entering the IP address of the IP Camera into a web browser (for example, IE) from a remote location. The user can instantly see the images shot by the IP Camera, and control the movement and direction of the shot remotely in order to choose the best position immediately on line.

The IP Camera is easy to install, and can be applied in a wide variety of applications, for example, monitoring property and taking care of children or the elderly; observing people or objects passing through specified commercial locations like offices, storehouses, shops etc. The IP Camera can also be used to observe the people or objects passing educational facilities like lecture halls, libraries, laboratories, etc. The above-mentioned applications allow the user to monitor environment.

However, IP Cameras from different brands have different types of instructions for fetching JPEG file format images. Therefore, people who want to combine multiple IP Cameras from different manufacturers and fetch their instant images must use specific Software Development Tool Kits (SDK) provided by the respective manufacturers. In addition, the use of the Software Development Tool Kits requires copyright royalties to be paid to the manufacturers, and human resources and working hours are consumed while trying to integrate IP Cameras of different brands. Therefore, it may cost large amounts of money to integrate the IP Cameras produced by different manufacturers (for example, Axis, Vivotek, Panasonic etc). And it is especially apt to take place when an organization purchases IP Cameras of different brands at different times.

FIG. 1 is a diagram showing a conventional integrated system 100 for grabbing images from IP Cameras of different brands. As shown, a Digital Video Recorder (DVR) 102 can connect multiple IP Cameras 111˜114 through the Internet 104 or Local Area Net (LAN) 106. Wherein, the Digital Video Recorder 102 can be a server, a person's computer or a bare system, and it can install the respective software and connect to the network. In the example in FIG. 1, because multiple IP Cameras 111˜114 are produced by different manufacturers, all Software Development Tool Kits provided by manufacturers, for example, Software Development Tool Kits 121˜124 of manufacturers 1˜4 should be installed on the Digital Video Recorder 102.

In the example of FIG. 1, when integrating different IP Cameras from different manufacturers to grab images, it requires large a lot of manpower, time and money in both management and development.

For the foregoing reasons, there is a need to provide an economic system that saves time and labor to integrate IP Cameras produced by different manufacturers in order to grab images shot by IP Cameras developed by different manufacturers in one system.

### SUMMARY

The present invention is directed to an image-grabbing system that uses an economic method that saves time and manpower to support IP Cameras produced by different manufacturers.

In accordance with one of the foregoing objectives, the present invention provides a system for grabbing images from an IP Camera, comprising: at least one IP Camera; and an IP Camera Module for sending a HTTP instruction to an embedded website of the IP Camera to request data, wherein the embedded website of the IP Camera receives the HTTP instruction and responds by sending image data in a JPEG file format to the IP Camera Module.

In accordance with other foregoing objectives, the present invention provides a method for grabbing images from an IP Camera, comprising steps of: inputting an IP address of an IP Camera; sending the IP address to an IP Camera Module; sending a HTTP instruction to an IP Camera of the IP address by the IP Camera Module; receiving the HTTP instruction and sending a response to the IP Camera Module by the IP Camera of the IP address; and receiving the response sent by the IP Camera by the IP Camera Module.

Another advantage is that the present invention supports all IP Cameras from different manufacturers with a standard protocol; the developer does not have to pay the IP Camera manufacturers any copyright royalties since the Software Development Tool Kit of the camera manufacturer is not used; the Digital Video Recorder can use image data to carry on further operations after receiving the image data; and, besides the IP Camera, both the web server and the video server are supported.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram showing a conventional system for grabbing images from IP Cameras;

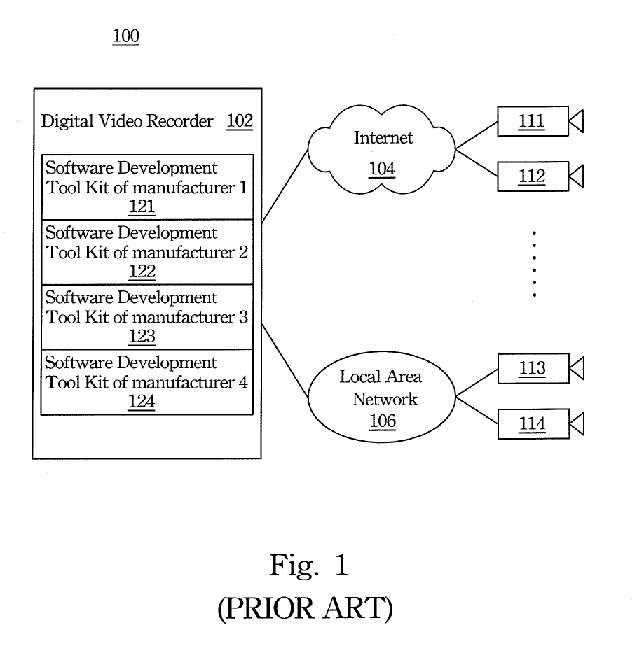

FIG. 2 is a diagram showing a system for grabbing images from IP Cameras according to one preferred embodiment of this invention; and

FIG. 3 is a flow chart showing a method for grabbing images from IP Cameras according to another preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Because most IP Cameras have web servers embedded thereof which are provided so that users can use a web browser to control the IP cameras or see images shot by the IP Camera. Therefore, according to one preferred embodiment of this invention, a system for grabbing images from an IP Camera, the system has a Digital Video Recorder (DVR) and an IP Camera Module installed, the IP Camera Module simulates the behavior of a web page navigator retrieving data from a web site when data is requested from an embedded website on the IP Camera to grab instant image data in JPEG image file format from the IP Camera. Image data from the IP camera is then sent to the Digital Video Recorder for processing.

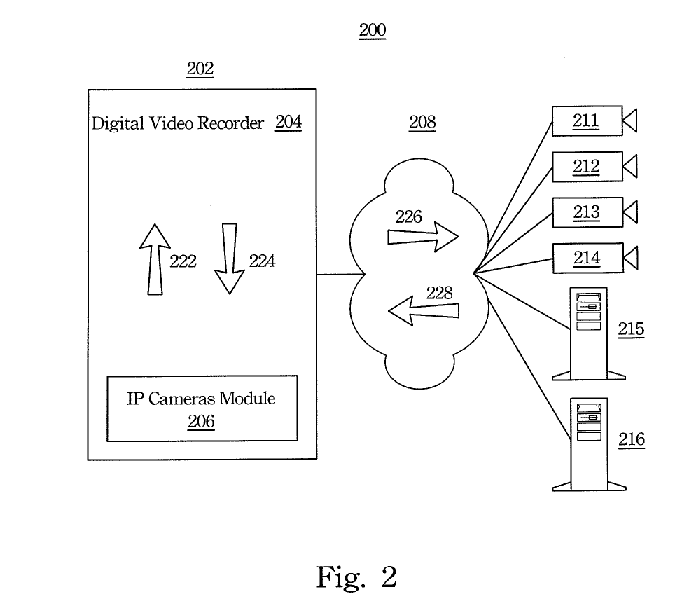

Refer to FIG. 2 illustrates a system 200 for grabbing images from IP Cameras according to one preferred embodiment of this invention. As shown, a Controller 202 comprises a mounted Digital Video Recorder 204 and an installed IP Camera Module 206. The Controller 202 connects multiple IP Cameras 211 214, one or more web servers 215, or one or more video server 216 by the Internet or a Local Area Network 208. Wherein, the Controller 202 can be a server, a PC or a bare system that can install the software thereof and connect to the network.

After the system has started, the Digital Video Recorder 204 sends an instruction to the IP Cameras Module 206, the IP Camera Module 206 then sends an instruction (step 224) requesting a JPEG image file from an IP Camera 211 through the network, for example:

Get /axis-cgi/jpg/image.cgi? resolution=640×480 HTTP/1.1

After the IP Camera 211 receives the instruction in Step 226, the IP Camera 211 sends a 640×480 JPEG image file to the IP Camera Module 206 in Step 228. Wherein, the data stream from the IP Camera 211 to the IP Camera Module 206 comprises the following format, for example:

HTTP /1.0 200 OK

Content-Type: image/jpeg

In the data stream, the above-mentioned example format is followed by the JPEG image data to be grabbed.

Finally, in Step 222, after the IP Camera Module 206 filters the retrieved data, only the image data is given to and processed by the Digital Video Recorder 204.

Because of the uses of HTTP instructions, the present disclosure can support not only IP Cameras but also all machines that have the properties of providing websites. According to another preferred embodiment of the invention, the present disclosure grabs the image data from a web server 215 or a video server 216.

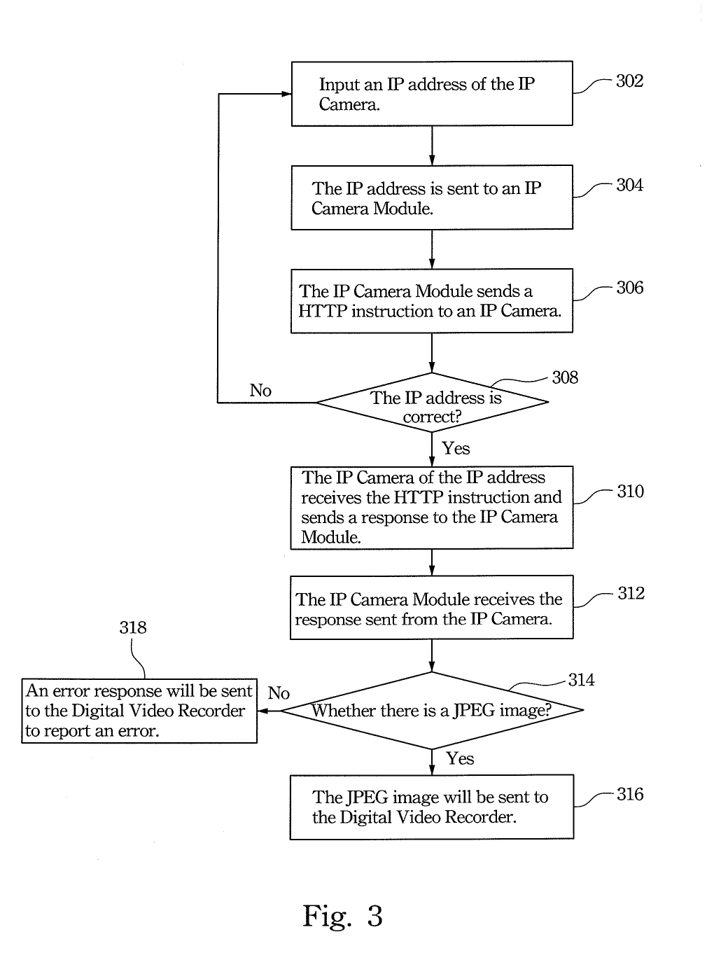

Refer to FIG. 3 which is a flowchart that illustrates a method for grabbing images from IP Cameras according to a further preferred embodiment of the invention. As shown, in Step 302, a user inputs an IP address of the IP Camera using an interface of a Controller in order to grab the images from the IP Camera. Wherein, the interface can be a web page or a window agent. In Step 304, the IP address is sent to an IP Camera Module. The IP Camera Module can simulate the behavior of the web browser to send a HTTP instruction to an IP Camera of the IP address (step 306). If the IP address is correct (step 308), the IP Camera with the IP address receives the HTTP instruction and sends a response to the IP Camera Module (step 310), wherein the response is a compressed JPEG image file. The IP Camera Module receives the response sent from the IP Camera (step 312), and then determines whether there is a JPEG image or not (step 314): if there is a JPEG image, the JPEG image will be sent to the Digital Video Recorder (step 316), or if there is no JPEG image, an error response will be sent to the Digital Video Recorder to report an error (step 318).

In the embodiments of FIG. 2 and FIG. 3, even if the IP Cameras, one or more web servers, one or more video servers 211˜216 are produced by different manufacturers respectively, the developer does not have to install all Software Development Tool Kits (for example, Software Development Tool Kits 121˜124) offered by manufacturers (manufacturers 1˜4) in the Controller 202 or the Digital Video Recorder 204.

From the above-mentioned preferred embodiments, the invention has the following advantages:
1. The system can integrate IP Cameras from different manufacturers by a single standard protocol, and the system is extensive so that there is no requirement to develop different products based on different manufacturers;
2. The developer does not have to pay the IP Camera manufacturers any copyright royalties since no Software Development Tool Kits from the manufacturers are used;
3. The Digital Video Recorder can use the image data to carry on further operations, for example, filming, dynamic detection, monitor and image processing, after receiving the image data; and
4. Besides the IP Camera, both web server and video server are supported.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for grabbing images from an IP Camera, comprising:
at least one IP Camera; and
an IP Camera Module for sending a HTTP instruction to an embedded website of the IP Camera to request data,
wherein the embedded website of the IP Camera receives the HTTP instruction and responds by sending a JPEG image file to the IP Camera Module.

2. The system of claim 1, further comprising:
a network device, wherein the IP Camera Module sends a HTTP instruction to a website of the network device to request the data, and the website of the network device receives the HTTP instruction, and responds by sending a JPEG image file to the IP Camera Module.

3. The system of claim 2, wherein the network device includes a web server or a video server.

4. The system of claim 1, further comprising a Digital Video Recorder (DVR) processing the image data that is received by the IP Camera Module.

5. A method for grabbing images from an IP Camera, comprising steps of:
inputting an IP address of an IP Camera by a interface;
sending the IP address to an IP Camera Module;
sending a HTTP instruction to an IP Camera of the IP address by the IP Camera Module;
receiving the HTTP instruction and then sending a response to the IP Camera Module by the IP camera at the IP address; and
receiving the response sent by the IP Camera by the IP Camera Module.

6. The method of claim 5, wherein the interface can be a web page or a window agent.

7. The method of claim 5, wherein the step of receiving the response made by the IP Camera by the IP Camera Module further comprises the step of:
determining whether the response contains a JPEG image file; and
the JPEG image will be sent to the Digital Video Recorder if there is a JPEG image, or an error response will be sent to the Digital Video Recorder to report an error if there is no JPEG image.
